(19) United States
(12) Patent Application Publication
(10) Pub. No.: US 2012/0070028 A1
(43) Pub. Date: Mar. 22, 2012

(54) Earphone system, apparatus, and method for enhancing personal safety

(76) Inventor: Steve Margulies, Palatine, IL (US)

(21) Appl. No.: 12/807,980

(22) Filed: Sep. 17, 2010

(51) Int. Cl. H04R 1/10

(52) U.S. Cl. 381/380

(57) ABSTRACT

An earphone system, apparatus, and method enables a user to simultaneously receive auditory stimuli from an earphone-based source and at least one secondary source thereby enhancing a user's personal safety while listening to earphone-based auditory stimuli. At least one primary earphone device having a loudspeaker is positioned adjacent the user's ear so as to allow aural perception of other, non-earphone-based auditory information or stimuli. In a preferred embodiment, an earphone device is both removably fastened and adjustable relative to underlying support structure so as to more properly direct earphone-based auditory stimuli toward the user's ear.

and does hereby declare that the following is a full, clear and exact description, reference being had to the accompanying drawings and to the numerals of reference marked thereon, which form a part of this specification.

### BACKGROUND OF THE INVENTION

1. Field of the Invention

The present invention generally relates to an earphone system and/or apparatus. More particularly, the present invention relates to an earphone apparatus for enabling users to remove or reposition an earphone otherwise positioned to direct auditory stimuli directly toward a user's ear canal to a position for enabling aural receipt of unobstructed auditory stimuli not only from the earphone device, but also from potentially dangerous sources of auditory stimuli in the user's vicinity.

2. Brief Description of the Prior Art

State of the art earphones and the like are typically designed to optimize sound quality. Sound quality optimization, however, often involves minimizing interference of peripheral auditory information from sources other than the earphone(s). This can lead to unsafe conditions insofar as the user may not be able to perceive auditory stimuli originating from potentially dangerous sources in the user's vicinity. Some of the more pertinent prior art relating to positioned placement of earphone-based loudspeakers and the like is briefly described hereinafter.

U.S. Pat. No. 6,526,635 ('635 patent), which issued to Nasu et al, discloses a Cord Clip. The '635 patent describes a cord clip for fastening a cord attached to e.g. an earphone to an object such as clothes. The cord clip includes a clipping portion for clamping the object and a cord holding portion for holding the cord. The clipping portion is formed by a first annular portion having a discontinuity at a part thereof. The clipping portion is capable of clamping the object at a clamping portion thereof provided by a narrow gap formed by the discontinuity of the first annular portion by means of an elastic resilient force of the first annular portion. The cord holding portion is formed by a second annular portion having a discontinuity at a part thereof. The cord holding portion is capable of holding the cord therein by means of an elastic resilient force of the second annular portion. This elastic resilient force of the second annular portion is independent of that of the first annular portion. The first annular portion and the second annular portion are formed integrally in a single member.

U.S. Pat. No. 6,771,790 ('790 patent), which issued to Liu, discloses an Ear Set for a Cellular Phone. The '790 patent describes an ear set for a cellular phone having a hollow body, an ear hook, an electric wire, a plug and a clip. The body has an earphone, a microphone, a pocket clip, a cap and a switch. One end of the pocket clip is attached to one end of the body. A protruding ball is mounted on the other end of the pocket clip above a hole through the body. The hole is located over a switch mounted inside the body so the protruding ball will contact and activate the switch when the pocket clip is pressed. This makes turning on or turning off the ear set easier and more convenient than pressing a discrete switch.

U.S. Pat. No. 6,772,853 ('853 patent), which issued to Yang, discloses a Clip-on Earphone Device. The '853 patent describes an earphone device having a clip-on member coupled to a connecting base via a resilient repositioning mechanism, wherein a chute is disposed at the bottom of the connecting base; a connecting member having a sliding element coupled to the chute such that the sliding element slides in the chute; and an earphone coupled to the connecting member via a positioning mechanism such that the earphone rotates in an angle range.

U.S. Pat. No. 6,819,772 ('772 patent), which issued to Amae, discloses a Personal Audio-Set with Pivoting Ear Clip Mount. The '772 patent describes a personal audio set, such as a headphone, earphone, or headset that includes a pivoting clip-type mounting portion is disclosed. A pair of arms are pivotally secured to the mounting portion to define a substantially c-shape for engaging the ear-base of a wearer's ear. Each arm is pivotally secured to the mounting portion preferably at a common first pivot, and biased to a neutral position with respect to each other. The arms move apart from each other about the pivot when being installed or removed from an ear, and seek to return to their neutral positions when placed on an ear, thereby securing the personal audio set on the base of a wearer's ear. Preferably, the mounting portion is also pivotally secured to the personal audio set at a second pivot hat is substantially perpendicular to the first pivot and biased to a neutral position such that the audio set is biased against the wearer's ear. More preferably, the mounting portion and personal audio set have a longitudinal center line and are a mirror image along that center line thereby allowing the personal audio set to be detachably secured to either a wearer's left or right ears.

United States Patent Application Publication No. US 2008/0196210, which was authored by

Liu et al., describes a combination Bluetooth earphone and a lanyard structure. The Bluetooth earphone includes an earphone body and a lanyard structure. The lanyard structure includes a lanyard and a clip element. The lanyard is disposed on the clip element. The clip element includes two hooks gripping the earphone body for combining the lanyard structure with the earphone body.

United States Patent Application Publication No. 2008/0207275, which was authored by Lin et al., describes a pair of eyeglasses having a Bluetooth wireless earphone which plays MP3 music is provided with a Bluetooth wireless earphone or a Bluetooth earphone with a built-in MP3 player which is fixed on a stand of an eyeglass frame by absorption with magnets, locking with locking buttons, or clipping with a clip.

United States Patent Application Publication No. 2009/0022352, which was authored by

Weibel, describes an ear-mounted audio device keeper includes a retainer, having has first and second ends, and a clip assembly at the first end, the clip assembly securable to an ear-mounted audio device. Each clip assembly can at least partially encircle and be secured to the ear-mounted audio device. The retainer can include a flexible but not stiff leash or a flexible, resilient headband. Some examples comprise a clip assembly at both the first and second ends, each clip assembly securable to an ear-mounted audio device, such as an earbud earphone. The audio device keeper can be used to maintain control over earbud earphones with the leash placed on one side of the user's neck and audio wires are placed on the other side of the user's neck.

United States Patent Application Publication No. 2009/0067658, which was authored by Lin, teaches a portable over-the-ear miniature sound box device comprises a loudspeaker, a first chamber and a second chamber. The loudspeaker is located in the first chamber. A first sound output hole of the first chamber is connected with a sound-receiving hole of the second chamber. A second sound output hole is disposed at the opposite side of the sound-receiving hole of the second chamber. A sound signal first resonates in the loudspeaker and is then sent through the first chamber to second chamber. Sound resonates again in the second chamber and is finally sent out via the second sound output hole. Because the sound signal resonates twice and is more convergent and the first resonance occurs in the loudspeaker, the bass will be thicker and more easily heard by human ears, hence solving the problem of easy divergence of the bass.

### SUMMARY OF THE INVENTION

A primary object of the present invention is to provide the user with an earphone or earbud device or apparatus that is capable of being selectively positioned so as to either directly deliver (i.e. the direction of sound wave movement is substantially orthogonal relative to the plane of the user's auricle or substantially parallel to the axis of the ear canal) or obliquely deliver (i.e. the direction of sound wave movement is angled relative to the plane of the user's auricle or ear canal axis) auditory information to the user's ear.

A further object of the present invention is to provide the user with an earphone or earbud device or apparatus wherein the loudspeaker portion is adjustable relative to secondary portions of the earphone or earbud apparatus such that the secondary portions may function to position or situate the entire apparatus, and the adjustable loudspeaker portion is adjustable at the apparatus site so as to enhance directed delivery of the earphone-based auditory stimuli toward the user's ear. To achieve these and other readily apparent objectives, the present invention essentially provides an earphone system, apparatus, and method enables a user to simultaneously receive auditory stimuli from an earphone-based source and at least one secondary source thereby enhancing a user's personal safety while listening to earphone-based auditory stimuli.

At least one primary earphone device having a loudspeaker is positioned adjacent the user's ear so as to allow aural perception of other, non-earphone-based auditory information or stimuli. In a preferred embodiment, an earphone device is both removably fastened and adjustable relative to underlying support structure so as to more properly direct earphone-based auditory stimuli toward the user's ear.

### BRIEF DESCRIPTION OF THE DRAWINGS

FIG. 1 is a fragmentary frontal perspective of a user wearing a collared shirt with a first type of earphone apparatus (i.e. a clip-on apparatus) according to the present invention removably attached to the collar of the user's shirt thereby enabling the user to aurally receive auditory stimuli from the first type of earphone apparatus and a generic secondary source.

FIG. 1(a) is an enlarged diagrammatic depiction of the first type of earphone apparatus according to the present invention inserted directly into a user's ear.

FIG. 2 is a fragmentary frontal perspective of a user wearing a collarless shirt with the first type of earphone apparatus according to the present invention removably attached to the neck-encircling portion of the user's shirt thereby enabling the user to aurally receive auditory stimuli from the earphone apparatus and a generic secondary source.

FIG. 2(a) is a fragmentary frontal perspective of a user wearing a collarless shirt with a second type of earphone apparatus (i.e. an around-the-neck apparatus) according to the present invention positioned around the posterior portion of a user's neck thereby enabling the user to aurally receive auditory stimuli from the earphone apparatus and a generic secondary source.

FIG. 2(b) is an enlarged diagrammatic depiction of the second type of earphone apparatus according to the present invention inserted directly into a user's ear.

FIG. 3 is a fragmentary frontal perspective of a user wearing a hooded jacket with an earphone apparatus according to the present invention removably attached to the hood of the user's jacket thereby enabling the user to aurally receive auditory stimuli from the earphone apparatus and a generic secondary source.

FIG. 4 is a front plan view of a first earphone apparatus according to the present invention showing upwardly directed alligator clip type structure operable to the right of the arm portion of the apparatus in a relaxed state for fastening the apparatus to support structure.

FIG. 5 is a front plan view of the first earphone apparatus according to the present invention otherwise shown in FIG. 4 and showing alligator clip type structure operable to the right of the arm portion of the apparatus in an actuated state for fastening the apparatus to support structure.

FIG. 6 is a fragmentary depiction of a lower portion of a second earphone apparatus according to the present invention showing downwardly directed alligator clip type structure operable to the right of the arm portion of the apparatus in a relaxed state for fastening the apparatus to support structure.

FIG. 7 is a front plan view of a third earphone apparatus according to the present invention showing upwardly directed alligator clip type structure operable to the left of the arm portion of the apparatus in a relaxed state for fastening the apparatus to support structure.

FIG. 8 is a front plan view of the third earphone apparatus according to the present invention otherwise shown in FIG. 7 and showing alligator clip type structure operable to the left of the arm portion of the apparatus in an actuated state for fastening the apparatus to support structure.

FIG. 9 is a fragmentary depiction of a lower portion of a fourth earphone apparatus according to the present invention showing downwardly directed alligator clip type structure operable to the left of the arm portion of the apparatus in an actuated state for fastening the apparatus to support structure.

FIG. 10 is a frontal depiction of an apertured arm portion with alligator clip type structure associated therewith for fastening the aperture arm portion to support structure.

FIG. 11 is a frontal depiction of an apertured arm portion with safety pin type structure associated therewith for fastening the aperture arm portion to support structure.

FIG. 12 is a frontal depiction of an apertured arm portion with flex clip type structure associated therewith for fastening the aperture arm portion to support structure.

FIG. 13 is a side depiction of the apertured arm portion otherwise depicted in FIGS. 10-12

FIG. 14(a) is a frontal depiction of an apertured arm portion with an elongate (elastomeric) sleeve running the length of the apertured arm portion through which sleeve extends a fragmentary temple structure (for supporting eyeglasses).

FIG. 14(b) is a depiction of an earphone apparatus received within an elongate (elastomeric) sleeve to which sleeve is attached a clip assembly.

FIG. 15 is a frontal depiction of an apertured arm portion with a series of three abbreviated (elastomeric) sleeves spaced along the length of the apertured arm portion through which sleeves extends a fragmentary wire.

FIG. 15(a) is a first enlarged sectional view as sectioned from FIG. 15 showing a slot formed in the abbreviated sleeve, which slot functions to elastomerically receive and retain the wire.

FIG. 15(b) is a second enlarged view as diagrammatically enlarged from FIG. 15(a) showing a slot formed in the abbreviated sleeve, which slot functions to elastomerically receive and retain the wire.

FIG. 15(c) is a third enlarged diagrammatic view showing an elastomeric sleeve (without slot), which sleeve functions to elastomerically receive and interface an eyeglass temple structure with a support structure.

FIG. 16 is a plan view of a first generic prior art behind-and-over-the ear type hook structure for placement behind and over a user's ear for positioning otherwise attached structure in adjacency to the user's ear.

FIG. 17 is a plan view of a second generic prior art behind-and-over-the ear type hook structure with attached earphone device, which hook structure is designed for placement behind and over a user's ear for positioning the earphone device in adjacency to the user's ear.

FIG. 18 is an edge view of the second generic prior art behind-and-over-the ear type hook structure with attached earphone device otherwise depicted in FIG. 17.

FIG. 19 is a plan view of a first behind-and-over-the ear type hook structure with an upper end swivel-attached earphone device according to the present invention.

FIG. 20 is an edge view of the first behind-and-over-the ear type hook structure with upper end swivel-attached earphone device otherwise depicted in FIG. 19 showing the swivel-attached earphone device positioned so as to direct auditory stimuli at an oblique angle relative to the plane of the behind-and-over-the ear type hook structure.

FIG. 21 is an edge view of the first behind-and-over-the ear type hook structure with upper end swivel-attached earphone device otherwise depicted in FIG. 19 showing the swivel-attached earphone device positioned so as to direct auditory stimuli orthogonally relative to the plane of the behind-and-over-the ear type hook structure.

FIG. 22 is a depiction of female snap-fit structure formed in a fragmentary arm end for receiving male snap-fit structure otherwise associated with an earphone device according to the present invention.

FIG. 23 is a plan view of a second behind-and-over-the ear type hook structure according to the present invention, which hook structure comprises an apertured upper end.

FIG. 24 is a plan view of a third behind-and-over-the ear type hook structure according to the present invention, which hook structure comprises a swiveling apertured upper end.

FIG. 25 is a plan view of a fourth behind-and-over-the ear type hook structure with an upper end female post-receiving structure and lower end post-hole mounted earphone device.

FIG. 26 is a plan view of a fifth behind-and-over-the ear type hook structure with an upper end C-clamp structure and an apertured lower end for receiving a posted earphone device (shown exploded in side view from the apertured lower end).

FIG. 27 is an edge view of a behind-and-over-the ear type hook structure with an upper end mounted earphone device oriented so as to deliver auditory stimuli orthogonally relative to the plane of the hook structure and a lower end mounted earphone device oriented so as to deliver auditory stimuli parallel relative to the plane of the hook structure.

FIG. 28 is a fragmentary view of a posted earphone device exploded from a female post-receiving structure formed in a behind-and-over-the ear type hook structure end.

FIG. 29 is a side view of a posted C-clamp according to the present invention for operable engagement with female post-receiving structure.

FIG. 30 is a plan view of a sixth behind-and-over-the ear type hook structure showing a grooved surface for receiving and guiding a signal-carrying wire.

FIG. 31 is a plan view of a seventh behind-and-over-the ear type hook structure showing V-shaped structures receiving and guiding a signal-carrying wire.

FIG. 32 is a plan view of an eighth behind-and-over-the ear type hook structure showing upper end swivel arm structure and lower end swivel arm structure.

FIG. 32(a) is an enlarged sectional view as sectioned from FIG. 32 showing two axes of rotation about which various portions of the swivel arm feature(s) rotate.

FIG. 33 is a diagrammatic depiction of a system of components showing behind-and-over-the ear type hook structures, each of which have an upper end-mounted earphone device and a lower end-mounted earphone device with signal carrying wires extending from each earphone device to a control mechanism for directing signals to the earphone devices.

FIG. 33(a) is a diagrammatic depiction of a system of components showing a central control mechanism adjacent a generic audio signal player with signal conducting wires radiating from the central control mechanism each of which is outfitted with a male connector.

FIG. 34 is a plan type depiction of a first around-the-neck type support structure showing an apertured first end and a second end outfitted with a C-clamp.

FIG. 35 is a plan type depiction of a second around-the-neck type support structure showing swivel or rotatable ends.

FIG. 36 is a plan type depiction of a third around-the-neck type support structure showing (1) a first end outfitted with a removably attachable and adjustable earphone device, and (2) a second end with integral and adjustable earphone device.

FIG. 37 is a frontal plan type depiction of an earbud device according to the present invention depicting adjustability about a first axis of rotation enabled by way of a ball joint.

FIG. 38 is a frontal plan type depiction of the earbud device otherwise depicted in FIG. 37 depicting adjustability about a second axis of rotation enabled by way of the ball joint.

FIG. 39 is a side plan type depiction of an earbud device otherwise depicted in FIGS. 37 and 38 depicting adjustability about a third axis of rotation enabled by way of the ball joint.

FIG. 40 is a side plan type depiction of an earbud device according to the present invention showing the earbud device in a joint-concealing/disabling configuration.

FIG. 41 is a side plan type depiction of the earbud device otherwise depicted in FIG. 40 depicting the earbud device in a joint-revealing/enabling configuration.

FIG. 42 is a plan view of a first arm portion (of an earbud assembly) having an apertured swivel upper arm feature according to the present invention.

FIG. 43 is a plan view of a second arm portion (of an earbud assembly) having an apertured upper arm feature according to the present invention.

FIG. 44 is a plan view of a series of three earphone assemblies; (1) the left most earphone assembly depicting both horizontal and vertical axes of rotation; (2) the middle earphone assembly depicting rotation about the horizontal axis of rotation relative to the left most earphone assembly, and (3) the right most earphone assembly depicting rotation about the vertical axis of rotation relative to the left most earphone assembly.

FIG. 45 is an enlarged side view depiction of an earbud having male snap-fit type prongs extending therefrom.

FIG. 46 is a fragmentary sectional view of an apertured arm portion (of an earbud assembly) with a C-clamp outfitted with male snap-fit type prongs being inserted through the aperture arm portion.

FIG. 47 is (1) a side view from top to bottom of (a) an earbud and (b) a snap-fit pronged C-clamp; and (2) a frontal view of an arm portion (of an earbud assembly) according to the present invention.

FIG. 48 is a fragmentary view of an end structure having female snap-fit structure according to the present invention.

FIG. 49 is an enlarged fragmentary view of an end structure having female snap-fit structure formed in a pivot ball joint according to the present invention.

FIG. 50 is a fragmentary view of end structure depicting a male ball joint exploded from an earbud having female structure formed therein.

FIG. 51 is a side view depiction of an earbud unit having laterally opposed and axially aligned female structures for receiving axially aligned male structure formed on an arm portion end (shown exploded from the earbud unit).

FIG. 52 is a frontal play type depiction of an arm portion (of an earphone or earbud assembly) showing the arm portion end otherwise depicted in FIG. 51 (with phantom earbud unit), which arm portion is outfitted with an alligator type clip according to the present invention.

FIG. 53 is a side view type depiction of the structures otherwise shown in FIG. 52 (with solidly drawn earbud unit).

FIG. 54(a) is a fragmentary view of an end structure showing internal indents for cooperable engaging outwardly radiating/ratcheting cog type structure.

FIG. 54(b) is a depiction of a pivot ball with outwardly radiating/ratcheting cog type structure for operably engaging the internal indents otherwise depicted in FIG. 54(a).

FIG. 55 is an exploded view of a first alternative earphone assembly according to the present invention depicting (1) in side view an arm post having sprocket type transverse structure for operable engagement with inwardly radiating cog type structure; and (2) in bottom view an earbud unit having inwardly radiating cog type structure.

FIG. 56 is an exploded view of a second alternative earphone assembly according to the present invention depicting (1) in side view an arm post having inwardly radiating cog type transverse structure for operable engagement with sprocket type structure; and (2) in bottom view an earbud unit having sprocket type structure.

FIG. 57 is a fragmentary exploded type depiction of a further alternative L-shaped earbud device adjacent a male connector, which connector has a signal-conducting wire extending therefrom.

FIG. 58 is a fragmentary exploded type depiction of a further alternative earbud device adjacent a male connector, which connector has a signal-conducting wire extending therefrom.

FIG. 59 is a fragmentary exploded type depiction of a further earbud device comprising two alternative female ports adjacent two male connectors, which connectors each have a signal-conducting wire extending therefrom.

FIG. 60 is a side view depiction of eyewear outfitted with an earphone assembly according to the present invention, which earphone assembly is attached to the temple structure via a series of abbreviated sleeves with a signal-conducting wire extending through the sleeves adjacent the temple with male connectors outfitted upon each end thereof.

FIG. 61 is a plan type depiction of a fourth around-the-neck type support structure showing arm-receiving structure at each end of the support structure for receiving arm portions of exemplary earphone devices.

FIG. 62 is a plan type depiction of the sixth behind-and-over-the ear type hook structure showing arm-receiving structure at each end of the hook structure for receiving arm portions of exemplary earphone devices.

FIG. 63 is a plan type depiction of a fifth around-the-neck type support structure showing female port structure positioned adjacent a male connector.

FIG. 64 is a plan type depiction of a sixth around-the-neck type support structure showing abbreviated sleeves for retaining signal-conducting wire(s) as positioned adjacent an audio signal player.

### DETAILED DESCRIPTION OF THE PREFERRED EMBODIMENT

Referring now to the drawings with more specificity, the preferred embodiment of the present invention concerns an earphone system for enabling a user to simultaneously receive auditory stimuli from an earphone-based source and at least one secondary source (such as noise sourced from traffic, animals, or similar other environmental source(s) as generically depicted by a box as referenced at 10) for the purpose of enhancing a user's personal safety while listening to or otherwise receiving earphone-based auditory stimuli (as at 100). In this last regard, as has been noted hereinabove, state of the art earphones often block or otherwise interfere with incoming auditory information and/or stimuli thereby handicapping the user's ability to properly perceive peripheral auditory information.

In this last regard, it is noted that peripheral auditory information (such as the auditory stimuli 101 emanating from secondary source(s) 10) may well be perceived to inform the earphone user of potential danger(s). In an effort to remedy or overcome potential dangers involved with earphone usage, the present invention enables users to attend to both earphone-based auditory information (as at 100) as well as auditory information derived from sources other than earphones (as at 101). It is thus contemplated that the earphone system according to the present invention comprises in combination at least one primary earphone device (as at 11) and certain earphone positioning means for enabling the user to position the primary earphone device 11 adjacent the user's ear 12 without contacting the user's ear 12.

The primary earphone device 11 according to the present invention preferably comprises a (miniature) loudspeaker 13 for converting electrical signals into earphone-based auditory stimuli 100, which earphone-based auditory stimuli 100 are receivable via a user's ear as at 12. A signal carrying wire 14 typically delivers the electrical signals to the loudspeaker 13, which loudspeaker converts the signals into stimuli 100. In this regard, it is contemplated that the primary earphone device 11 may be outfitted with, certain wire-retaining means for retaining the wire 14 or similar other signal conductor against or in parallel relation to an arm portion (as at 15) of the earphone device 11.

The earphone positioning means are preferably outfitted upon or interconnected with the arm portion 15 for enabling the user to position and adjust the primary earphone device 11 with loudspeaker 13 adjacent the user's ear 12 (without contacting said ear 12) so that the user may be able to more properly direct auditory stimul±100 toward the ear (canal) 12. In this last regard, it will be recalled that a primary object of the present invention is to provide the user with an earphone or earbud device or apparatus that is capable of being selectively positioned so as to either directly deliver (i.e. the direction of sound wave movement is substantially orthogonal relative to the plane 121 of the user's auricle 91 or substantially parallel to the axis 120 of the ear canal 90) or obliquely deliver (i.e. the direction of sound wave movement is angled relative to the plane of the user's auricle 91 or ear canal axis 120) auditory information to the user's ear 12.

The earphone positioning means thus enable auditory information and/or stimuli as at 101 emanating from at least one secondary source (as generically depicted at 10) to be simultaneously and unobstructedly received by the user's ear 12 for enhancing the user's personal safety while receiving to the earphone-based auditory stimuli 100. In other words, the earphone positioning means distances the primary earphone device 11 from the user's ear 12 thus enabling additional, secondary source auditory information to enter the ear 12 without obstruction or interference from the physical boundaries of the primary earphone device 11.

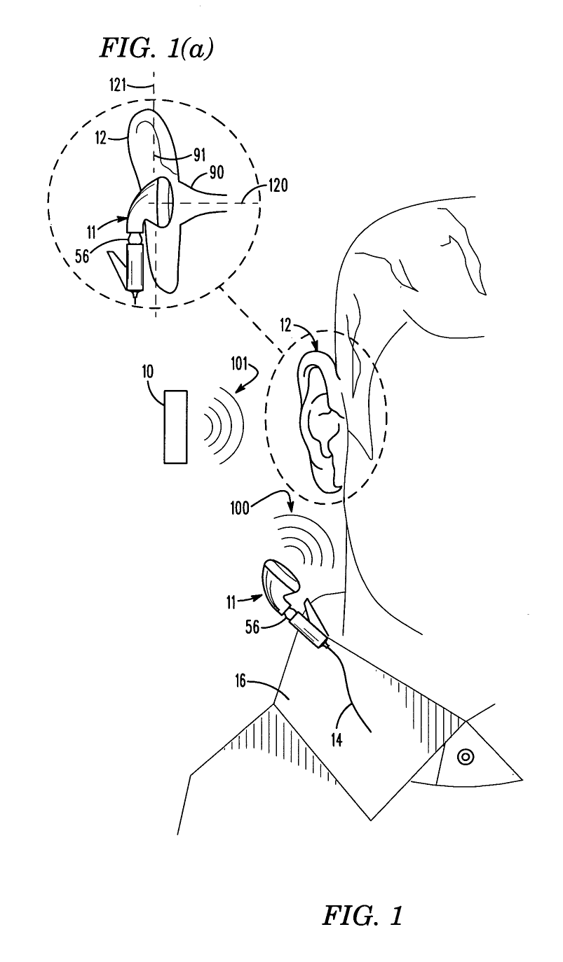

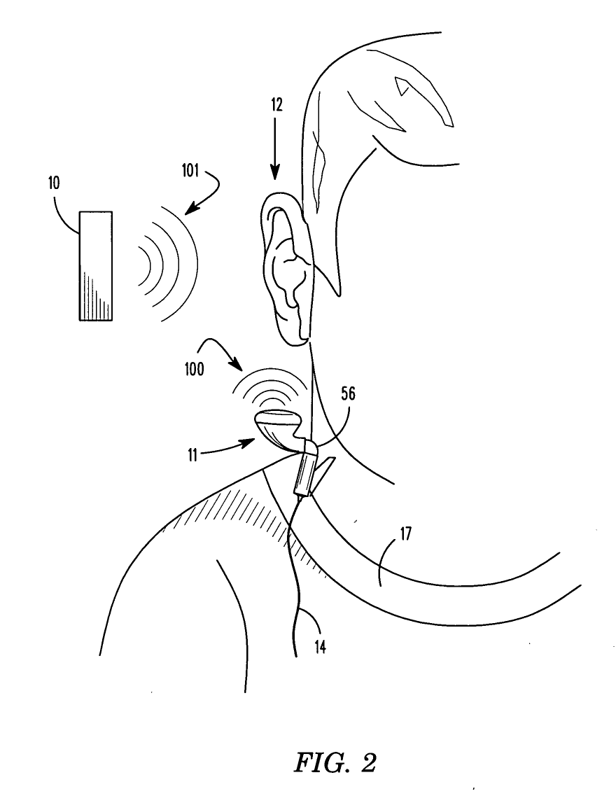

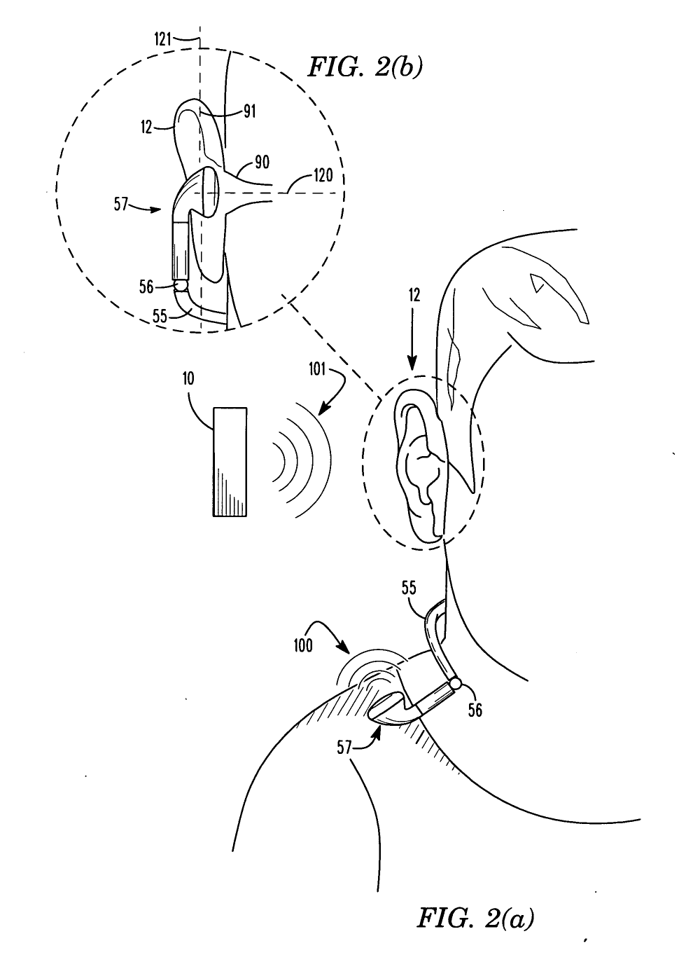

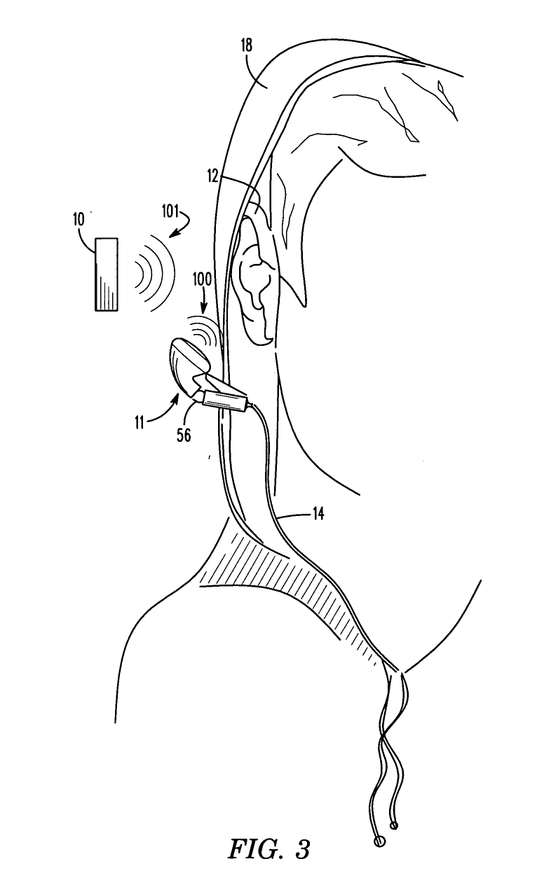

It is contemplated that the earphone positioning means may be exemplified by any number of structures, including certain fastening means for enabling the user or removably fasten the primary earphone device 11 to articles of clothing worn by the user. In this regard, the reader is directed to FIGS. 1-3 which generically and respectively depict a fragmentary user wearing a collared shirt 16 (as depicted in FIG. 1); a collarless shirt 17 (as depicted in FIGS. 2 and 2(a)); and a hooded jacket 18 (as depicted in FIG. 3). The fastening means as variously defined or exemplified may preferably be integrally formed with the arm portion 15 of the primary earphone device 11 or affixed thereto. So long as the primary earphone device may be removably attached to certain earphone support structure (such as clothing or other exemplified support structure) adjacent the ear 12, it is contemplated that the fastening means according to the present invention are practiced.

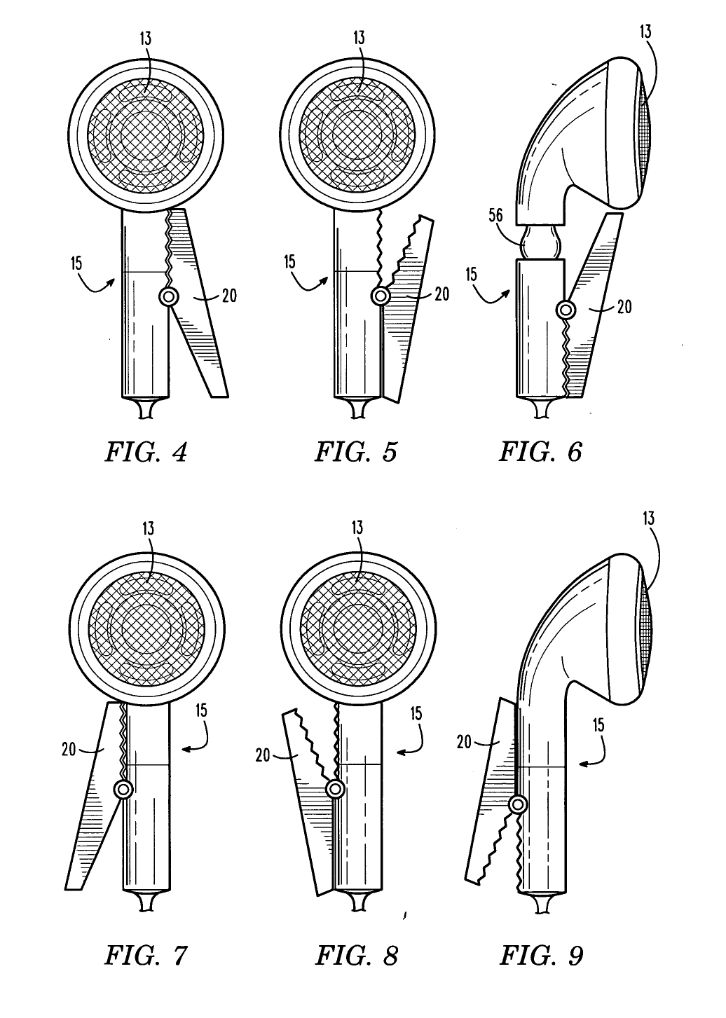

A first preferred example of certain fastening means is depicted in FIGS. 4-9. Referencing the noted figures, the reader will understand that an alligator type clip 20 may be incorporated into the primary earphone device so as to enable the user to clip or removably fasten the primary earphone device to certain earphone support structure such as article(s) of clothing.

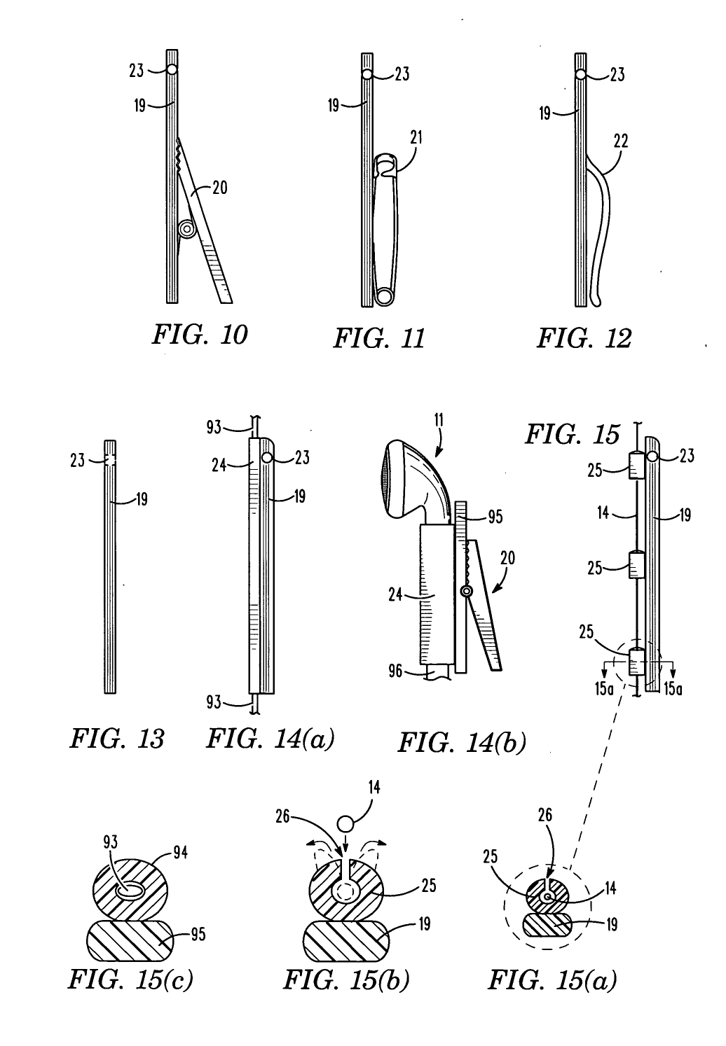

Other alternative examples of certain fastening may include a safety pin 21 attached to an arm portion 19 (of the primary earphone device) as depicted in FIG. 11 or a resilient pen type clip 22 attached to an arm portion of the primary earphone device as depicted in FIG. 12. The arm portion 19 depicted in FIGS. 10-13 comprises an aperture as at 23 for accepting male structure associated with a miniature loudspeaker for holding such a loudspeaker adjacent the arm portion 19.

It is contemplated that the arm portion(s) 15 or 19 may be outfitted with certain wire retaining means as earlier mentioned. In this regard, the reader is directed to FIGS. 14(a) and 15. From an inspection of FIGS. 14(a) and 15, it will be seen that the arm portion(s) may be outfitted with an elongate resilient sleeve-like member as at 24 or a series of spaced, abbreviated sleeves as at 25. It is contemplated that the member 24 or sleeves 25 may well function to retain a wire 14, eyeglass temple structure 93, or similar other signal carrying element in parallel relation to the arm portion(s) 15 and/or 19. Referencing FIGS. 15(a) and 15(b) it will be further understood that the sleeves 25 may be provided with a slit as at 26 for receiving a wire 14, which slit is bound by elastically deformable material for actuably receiving the wire 14 (as diagrammatically depicted in FIG. 15(b)) and relaxably retaining the wire 14 (as diagrammatically depicted in FIG. 15(a)).

Referencing FIG. 15(c), it is further contemplated that an elastomeric sleeve 94 otherwise having no slit or notch to receive structure (such as a template structure 93 or wire 14) transversely but rather axially) may receive such structure and be attached to post structure as at 95. Further referencing FIG. 14(b), it will be seen that the shaft 96 of an earphone or earbud device 11 may be received by a slotted sleeve 24, which sleeve 24 may be attached to post-like structure 95 as perhaps outfitted with means for removably fastening the assembly to support structure as exemplified by an alligator type clip 20.

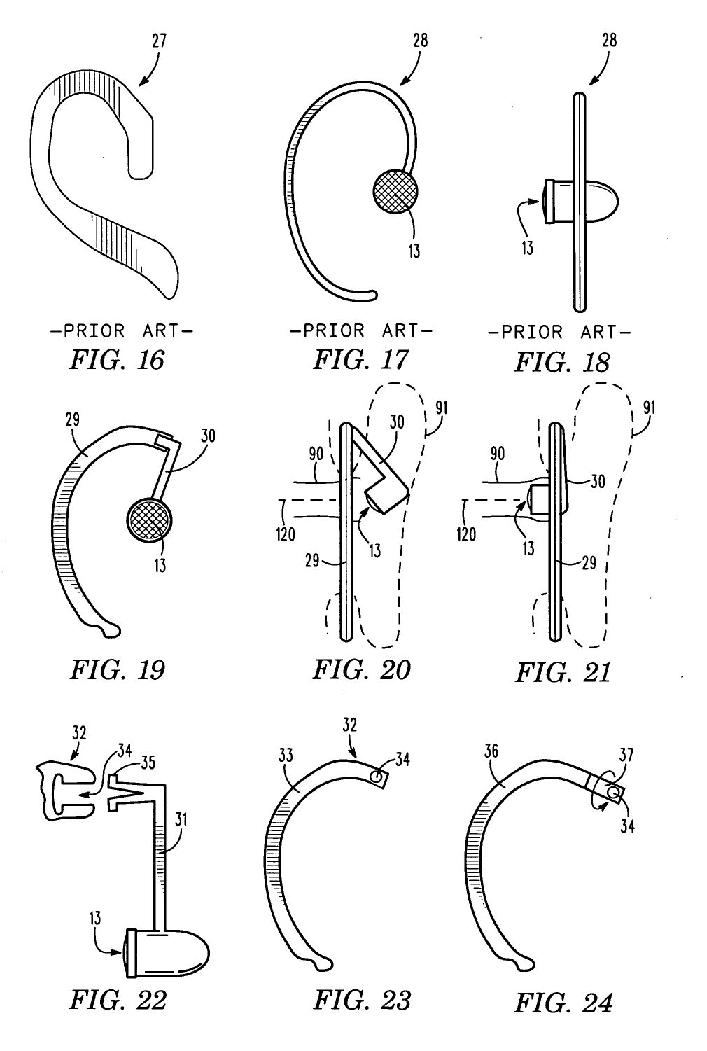

Other earphone positioning means may be exemplified by roughly question mark-shaped (i.e. ?-shaped) or C-shaped headband-free, clip-on or over-the-ear structure(s) as generically depicted in FIGS. 16-33. From an inspection of the noted figures, it will be seen that a number of various designs are contemplated for such C-shaped headband-free, clip-on, or over-the-ear structures. In this regard, it is noted that such structures are commonly practiced for placing miniature loudspeakers in the vicinity of the ear canal since these headband-free clip-on style structures generally follow the contour of the back side of the ear at the ear-to-head junction.

FIG. 16 is a plan type depiction of a first behind-and-over-the-ear type structure 27. FIG. 17 is a plan type depiction of a second behind-and-over-the-ear type structure 28 with a loudspeaker 13 attached to the upper terminus of the structure 28 for use with a left ear. FIG. 18 is a end view type depiction of a second behind-and-over-the-ear type structure 28 with a loudspeaker 13 attached to the upper terminus of the structure 28 for use with a right ear. FIGS. 19-21 depict a third behind-and-over-the-ear type structure 29 having a movable or pivotable or swivel type earphone device 30 (with loudspeaker 13) attached thereto. It is contemplated that this assembly would enable the user to position the device 30 so as to orient the loudspeaker 13 either (1) directly into the ear canal (as generally depicted in FIGS. 19 and 21) or at an oblique angle relative to the ear canal (as generally depicted in FIG. 20).

FIG. 22 depicts a snap fit type junction between an ear bud device 31 and the upper end 32 of a fourth C-shaped behind-and-over-the-ear type structure as at 33 in FIG. 23. It will be seen from a comparative inspection of FIG. 22 versus FIG. 23 that the upper end 32 comprises an aperture 34 for receiving the male end of the device 31. The device 31 comprises flexible prongs 35 which may be pressed together so as to enable the prongs 35 to be inserted into the aperture 34 for snap-fitting the device 31 to the structure 33. FIG. 24 depicts a fifth behind-and-over-the-ear type structure 36 comprising a swivel or rotatable end 37, which end 37 is rotatable relative to the C-shaped portion 38 of the structure 36. The rotatable end 37 may comprise an aperture of the type referenced at 34 or similar other type aperture as at 23.

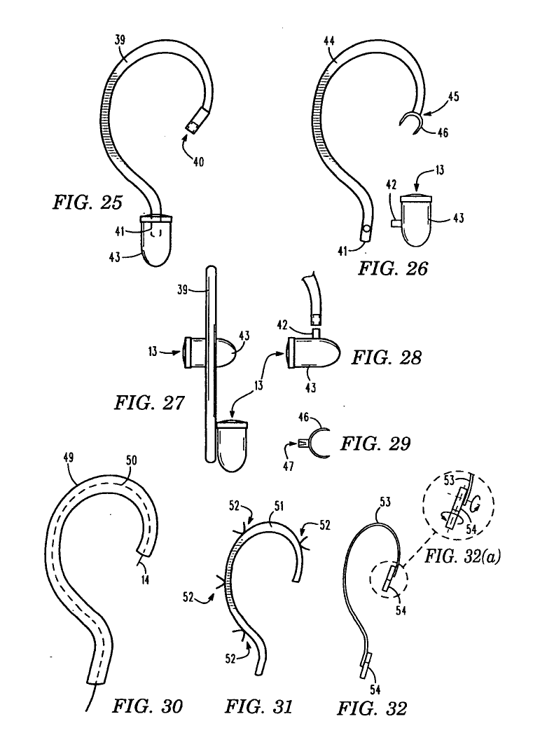

FIG. 25 is a plan type depiction o a fifth behind-and-over-the-ear type structure 39 having an upper terminus 40 and a lower terminus 41. The upper terminus is outfitted with an aperture tip for receiving a post 42 as formed with an earbud device 43 (having a loudspeaker 13) as generally depicted in FIGS. 26 and 28. FIG. 26 is a plan type depiction of sixth behind-and-over-the-ear type structure 44 having a lower terminus 41, but an upper terminus 45. The upper terminus 45 comprises a C-clamp 46 for receiving an earphone device at the upper terminus 45. It is contemplated that the C-clamp 46 may be outfitted with snap-fit prongs 47 similar to the prongs 35 for snap-fit insertion into an aperture 34 of the type depicted in FIG. 22. It will thus be understood that structures 39 and 44 are designed to position two earphone devices adjacent the ear 12, one at relatively greater elevation and one at relatively lesser elevation.

If viewed as a question mark shaped behind-and-over-the-ear type structure, the lower terminus or arm is outfitted with certain means for receiving and supporting an earphone device so as to enable the user to position an earbud or earphone device in inferior adjacency to the ear 12, as well as either (1) directly in to the ear canal (as generally depicted in FIG. 27 (and FIGS. 19 and 21)) or (2) at an oblique angle relative to the ear canal (as generally depicted in FIG. 20). In this regard, although not specifically illustrated, it is contemplated that a structure of the type generally referenced at 39 and/or 44 could well be outfitted with a swivel mechanism of the type generally referenced at 30. This would enable the behind-and-over-the-ear type structure to position two earphone devices adjacent a single ear, yet enable the user to receive unobstructed secondary source auditory information as at 101.

In addition to the sleeve member 24 and short sleeves 25, it is contemplated that other structures may be associated with behind-and-over-the-ear type structures for enabling the signal-carrying wire 14 or similar other conductor to be positioned in parallel relation relative to the axis or axes of the means for positioning the earphone device. In this regard, the reader is directed to FIGS. 30 and 31. FIG. 30 is a plan type depiction of a behind-and-over-the-ear type structure 49 having a wire-grooved track as at 50 for receiving a wire 14. FIG. 31 is a plan type depiction of a behind-and-over-the-ear type structure 51 comprising V-shaped notches or elements 52 for receiving and retaining a wire in parallel relation to the axis or axes of structure 51. FIG. 32 depicts a behind-and-over-the-ear type structure 53 having swivel arms 54 at the upper and lower termini for enabling swivel action at the termini.

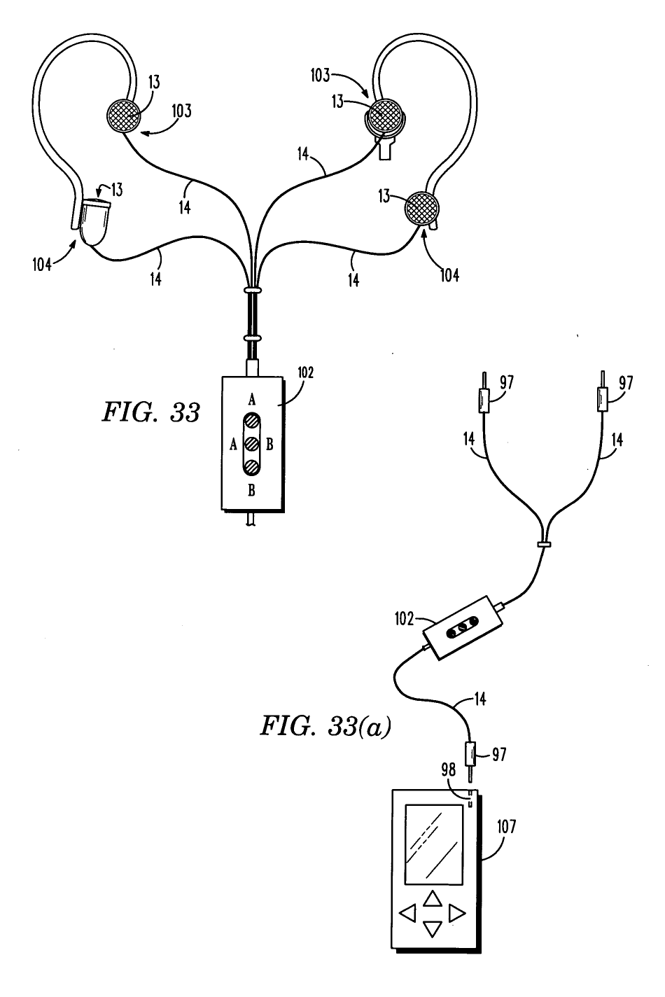

FIG. 33 depicts a system of components designed to enable the user to position two earphone device(s) adjacent each of the user's ears. Each earphone device comprises a miniature loudspeaker 13 and is attached to a behind-and-over-the-ear type structure as exemplified by the foregoing examples. Preferably the behind-and-over-the-ear type structure enables the user to tri-axially position the earphone device so as to direct auditory information towards the ear (canal) while simultaneously allowing secondary source auditory information to also be received by the ear. Thus the system enables the user to perceive not only auditory information/stimuli (as at 100) from the earphone device(s), but also auditory information/stimuli (as at 101) from potential sources of danger so as to enhance the user's personal safety while attending to earphone-based auditory information.

It will be further understood form a consideration of FIG. 33 that the present invention contemplates certain means for directing or controlling electrical signal delivery to the earphone device(s) which means are generically depicted and referenced at 102. Signal delivery can be thus be controllably directed from an audio signal player 107 via signal conducting wire(s) 14 or means solely to either upper earphone devices as at 103; solely to lower earphone devices as at 104, or simultaneously to both upper and lower earphone devices 103 and 104. It is contemplated that the control means 102 may comprise certain means for controlling volume, for example. If the upper earphone devices 103 are positioned so as to direct auditory information directly toward the ear, a lower volume may be preferably selected, whereas if the upper earphone devices 103 are positioned so as to direct auditory information at an oblique angle relative to the ear (canal), then a higher volume may be preferably selected.

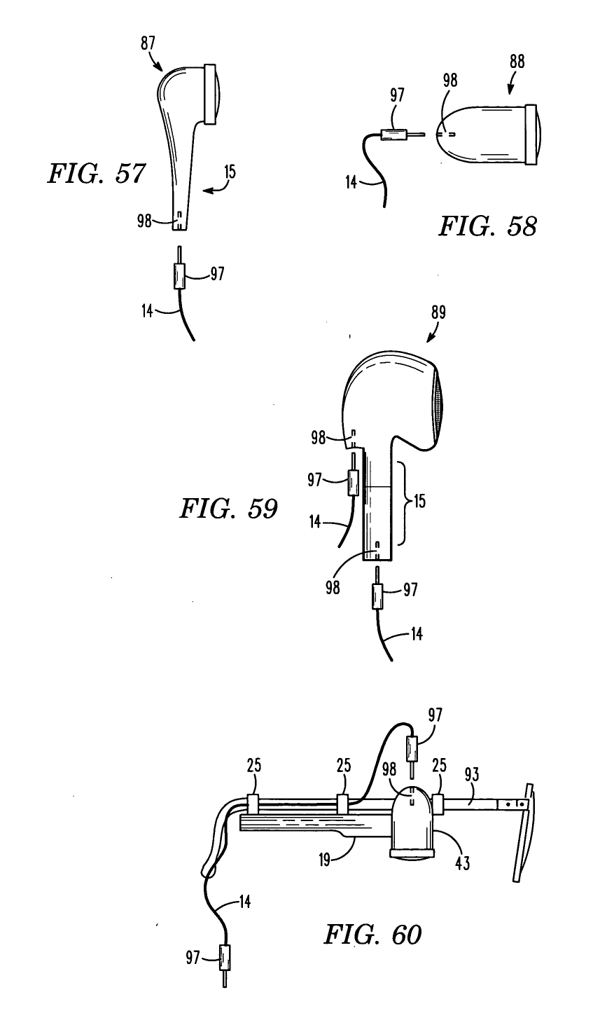

FIG. 33(a) is believed to introduce the concept of male connectors as at 97. In this regard, it is contemplated that male connectors 97 may be received by female ports 98 formed in any number of the earbud or earphone devices shown or otherwise supported by this specification. The reader is directed to FIGS. 57-60 for example, which figures comparatively show a series of alternative earbud devices as at 87, 88, and 89 outfitted with female ports 98. Notably, earbud device 89 comprises a head portion 106 and an arm portion 15. Head portion 86 comprises a female port 98 configured or aligned so that a male connector 97 may be received such that the axes thereof are substantially parallel to the arm portion 15. The axis of the female port 98 may also be oriented orthogonally relative to the speaker 13 as generally shown in FIGS. 58 and 60.

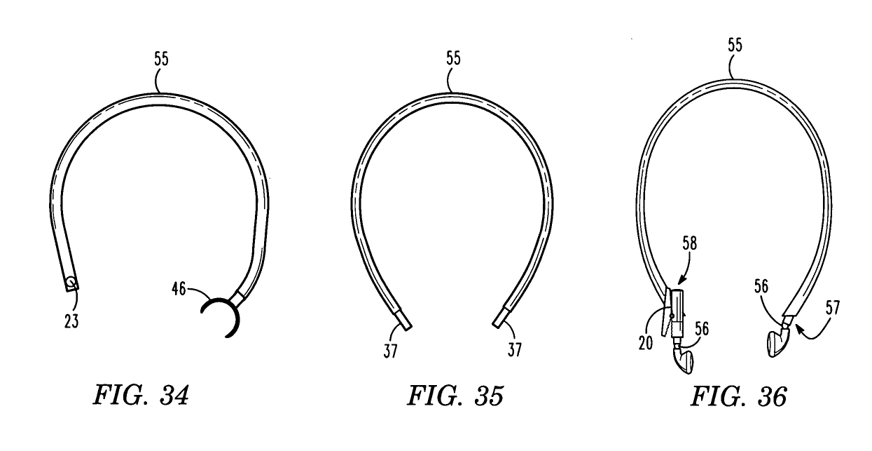

Other earphone positioning means may be exemplified by roughly U-shaped around the neck structures as generally depicted and referenced in FIGS. 34-36. The U-shaped portion 55 may preferably be constructed from or comprise flexible materials and/or ductile (form-fittable) materials so as to enable the user to form fit the U-shaped portions about the posterior portions of the user's neck. The termini may be outfitted any type of snap fit feature, a post hole as at 23; a C-clamp as at 46; a swivel arm as at 37; a pivot ball or ball joint as at 56 (either (a) integrally formed as at 57 or (b) removably attached (e.g. via an alligator clip type structure 20)) as at 58). The central concept being addressed is that the earphone positioning means enable the user to position the respectively earphone devices in a tri-axial manner so as to enhance the directed delivery of auditory information/stimul±100 toward the user's ear.

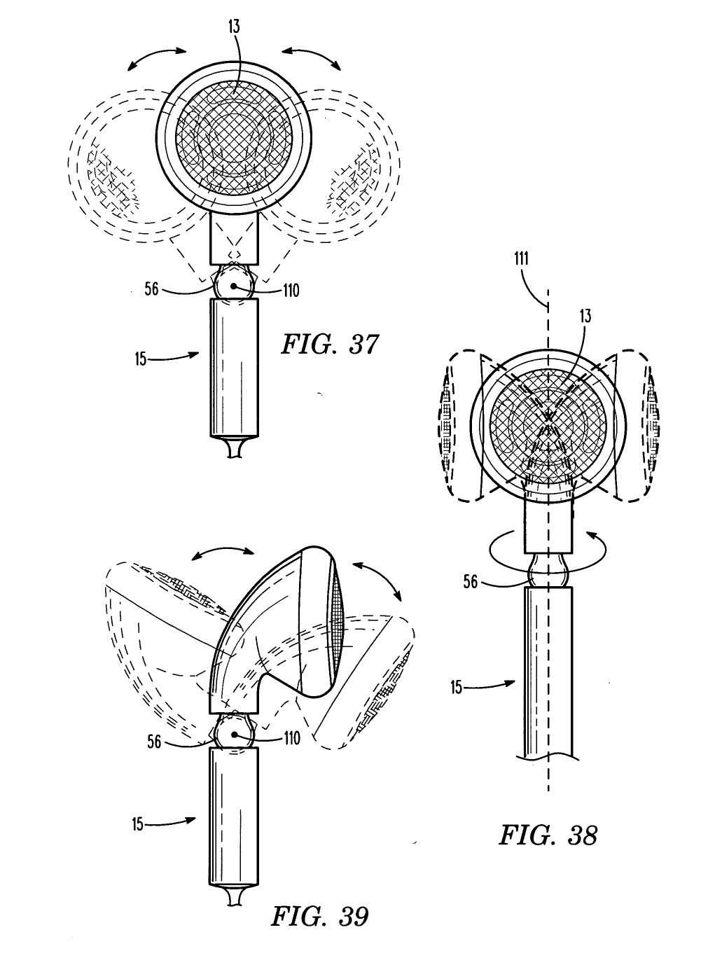

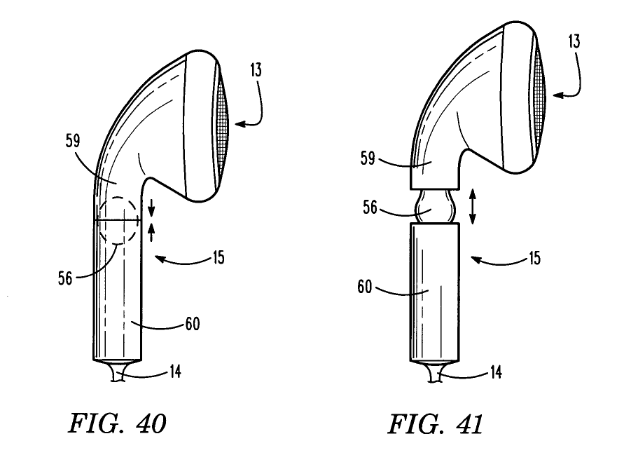

The reader is thus directed to FIGS. 37-39, which figures comparatively depict an ear bud tri-axially adjustable about a first pivot axis 110; a second pivot axis 111; and a third pivot axis 112. A ball joint 56 is depicted in FIGS. 37-39 as representative of a preferred type of structure for effecting tri-axial movement and/or adjustability. Referencing FIGS. 40 and 41, however, it is further contemplated that the ball joint 56 or similar other means for effecting tri-axial movement/adjustment may be prevented by axially displacing the arm portions 59 and 60 toward one another thereby concealing the ball joint 56. Conversely, the arm portions 59 and 60 may be axially displaced away from one another to expose and/or enable the ball joint 56 or tri-axial means for movement/adjustment. In any event, the described earphone adjustment means are contemplated so as to enable the user to tri-axially adjust the primary earphone device for enhancing directed delivery of the earphone-based auditory stimuli toward the user's ear.

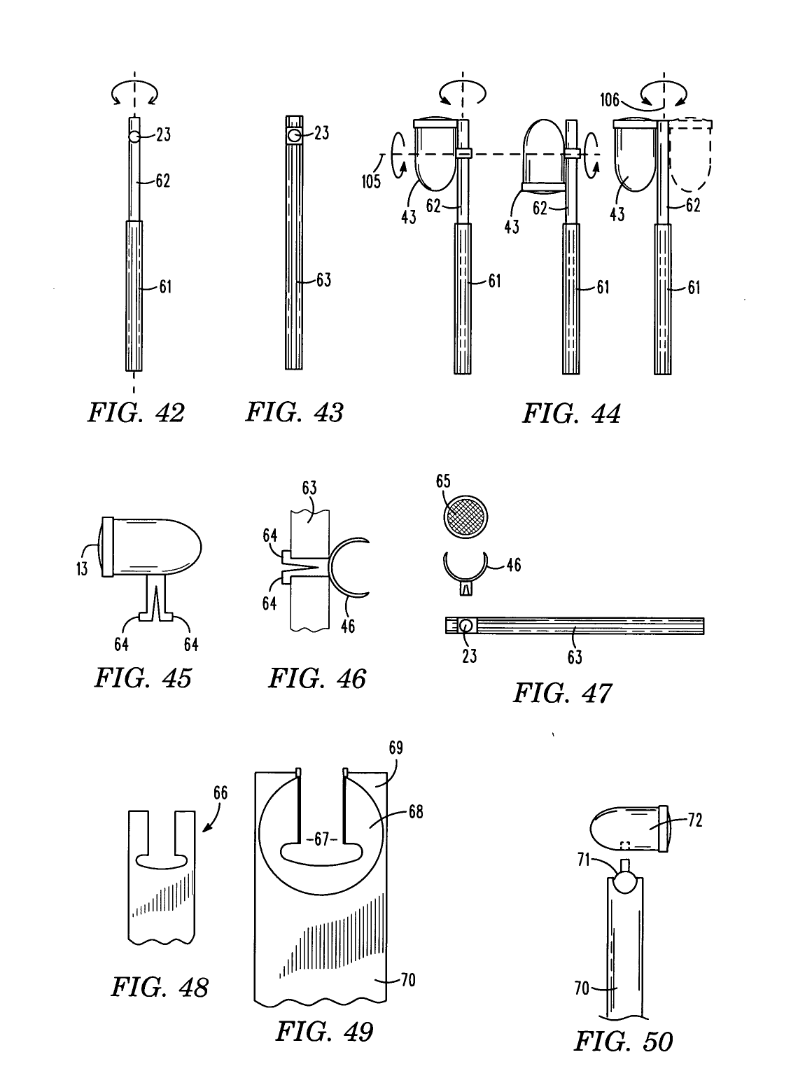

Various other means for effecting tri-axial means for movement/adjustment are contemplated as further depicted in the various figures. FIG. 42 depicts an earphone arm portion 61 having a rotatable end 62 with an aperture 23 formed therein. Comparatively, FIG. 43 depicts an earphone arm portion 63 having an aperture 23 formed therein, which arm portion does not include a rotatable end. It is thus contemplated that the structure depicted in FIG. 43 enables the user to attach an earbud or earphone device such as that depicted at 43 to the rotatable end 62 for enabling the user to rotate the earbud device 43 (1) about an axis extending through the post 42 as at axis 105, or (2) about an axis extending through the rotatable end 62 as at axis 106.

Element 43 is depicted in a slightly enlarged view in FIG. 45. It may be seen that the post 42 may comprise snap fit type prongs 64 for receipt by the aperture 23. Conversely, a C-clamp as at 46 may be outfitted with snap fit type prongs 64 for similar insertion through aperture 23 (as formed in either rotatable end 62 or arm portion 63. FIG. 46 demonstrates this latter structural scenario. FIG. 47 depicts an arm portion 63, a C-clamp 46, and a postless earbud device 65 in exploded relation depicting a structural arrangement given the noted components.

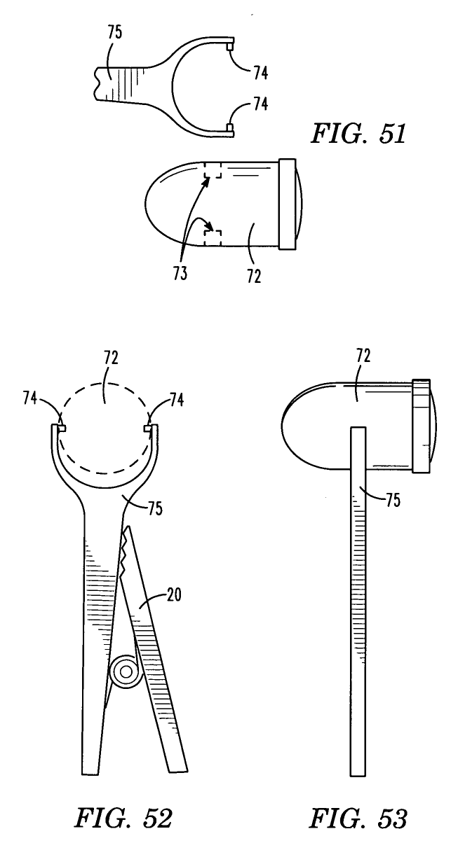

A female snap fit end 66 is generally depicted in FIG. 48 and a female snap fit pivot ball joint is depicted in FIG. 49. It is contemplated that the female snap fit end 66 may function to receive prongs such as prongs 64 or prongs 35. Further the female structure 67 of the structure depicted in FIG. 49 may receive said prongs. However, the female structure 67 is formed within a ball joint 68, which joint 68 is outfitted in an end 69 of an arm portion 70 so as to enable tri-axial movement at the end 69. FIG. 50 depicts a male ball joint 71, which male ball joint may couple with female structure formed in earbud unit(s) 72. FIG. 51 depicts an earbud unit with laterally opposed female structure 73 for receiving axially aligned male structure 74 formed on an arm portion end 75. FIGS. 52 and 53 depict alligator clips 20 integrally formed with the arm portion having end 75.

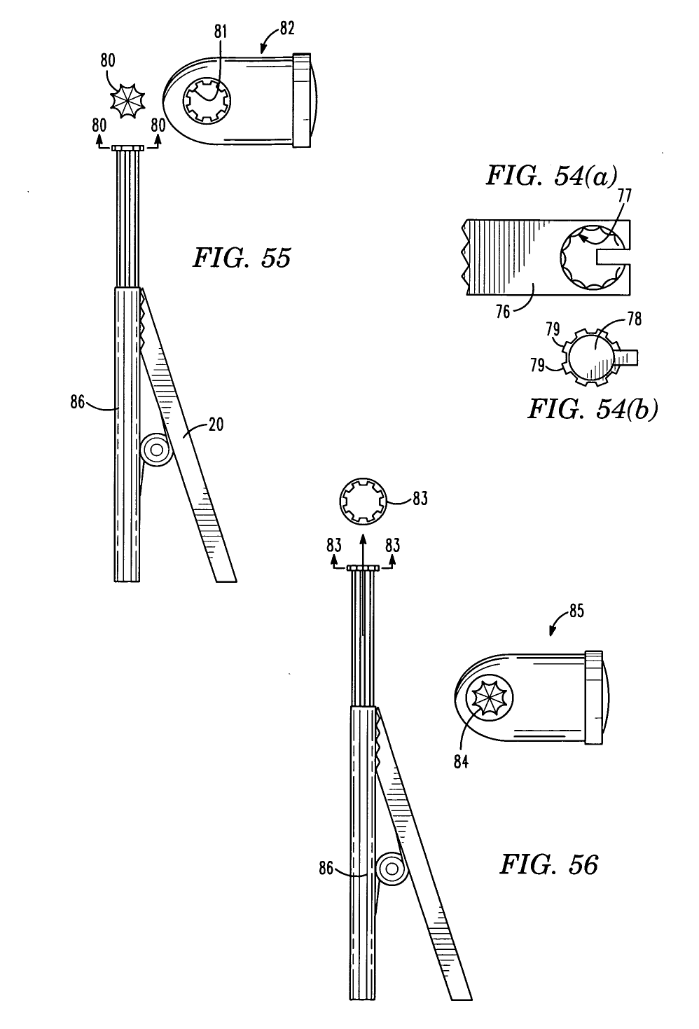

FIG. 54(a) is a depiction of an arm end 76 with internal indents 77 and FIG. 54(b) is a depiction of a pivot ball 78 with ratcheting cogs 79. FIG. 55 depicts an arm post having sprocket type transverse structure as at 80 for operative engagement with cogs 81 formed in an earbud unit 82. Conversely, FIG. 56 depicts an arm post having internal cog type structure 83 for operative engagement with sprocket type structure 84 formed in an earbud 85. Both the posts have alligator clip type structure 20 associated therewith as an example of certain means for fastening the arm portions 86 to structure adjacent a user's ear 12.

While the foregoing sets forth much specificity, this specificity should not be construed as limitations on the scope of the invention, but rather as an exemplification of the invention. For example, as is described hereinabove, it is contemplated that while the present invention essentially discloses an earphone apparatus for enabling a user to simultaneously receive auditory stimuli from an earphone-based source and at least one secondary source, such as noise emanating from (perhaps dangerous goings on) nearby. It is contemplated that the earphone apparatus according to the present invention may well function to enhance one's personal safety while listening to earphone-based auditory stimuli.

The earphone apparatus according to the present invention preferably and essentially comprises at least one primary earphone device as at 11 and certain earphone positioning means. The primary earphone device comprises a miniature loudspeaker as at 13 for converting electrical signals into earphone-based auditory stimuli as at 100, which earphone-based auditory stimuli are receivable via a user's ear as at 12. The earphone positioning means (as exemplified my any number of means described by the foregoing) function to enable the user to position the primary earphone device adjacent the user's ear without contacting said ear so that auditory information from at least one secondary source may be simultaneously and unobstructedly received by the user's ear for enhancing the user's personal safety while receiving to the earphone-based auditory stimuli. The earphone apparatus according to the present invention may further comprise certain fastening means for enabling the user or removably fasten the primary earphone device to articles of clothing worn by the user. The fastening means are believed to be further exemplified by various foregoing descriptions and supporting illustrations. The earphone apparatus may further comprise certain earphone adjustment means for enabling the user to tri-axially adjust the primary earphone device for enhancing directed delivery of the earphone-based auditory stimuli toward the user's ear. In this last regard, it is contemplated that a ball joint may well provide the basis for tri-axial movement/adjustment, but that any number of other structural means may effect similar adjustment capability.

The means for enabling triaxial adjustment as exemplified by a ball joint may be enabled by axially displacing a first earphone arm portion as at 59 away from a second earphone arm portion as at 60 (or from a first arm configuration generally depicted in FIG. 40 to a second arm configuration as generally depicted in FIG. 41). The ball joint or similar other means for enabling triaxial adjustment is otherwise concealed and disabled when the first and second earphone arm portions are in the first earphone arm configuration.

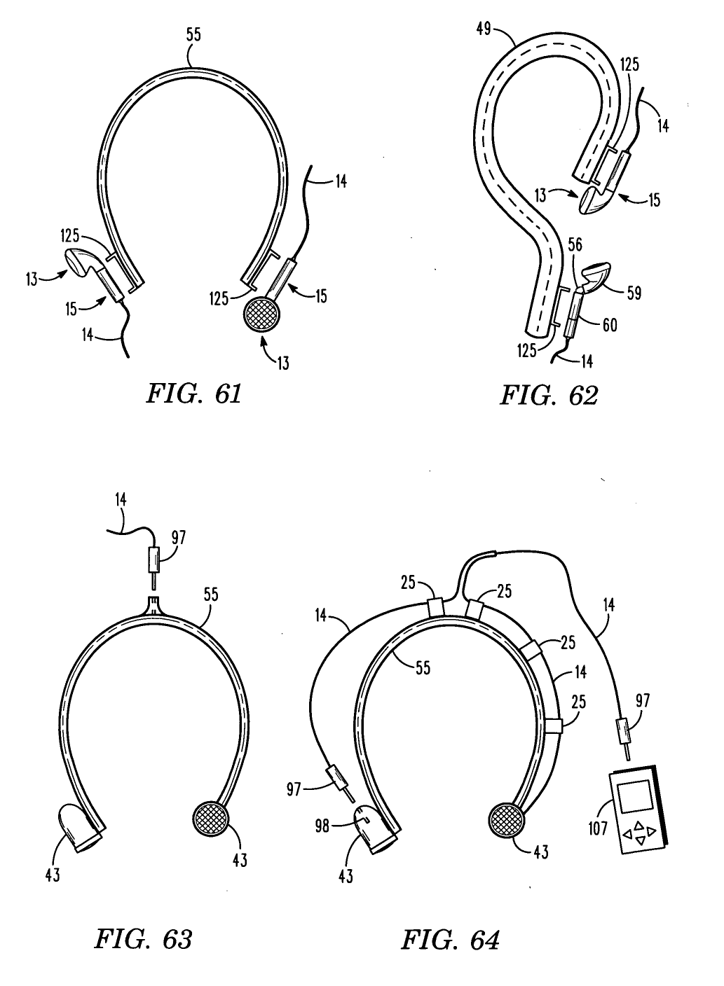

Any number of fastening means may be utilized to fasten any number of earbud devices to support structure for enabling the user to (re)position the earbud devices adjacent a user's ear 12 for enhancing directed auditory stimuli delivery. In this regard, and in addition to the number of examples already cited, the reader is directed to FIGS. 61-64. FIG. 61 is a plan type depiction of a further altertative around-the-neck type support structure having U-shaped structure 55 showing snap-fit type arm-receiving structure 125 at each end of the structure 55 for receiving arm portions 15 of exemplary earphone devices. The arm-receiving structures 125 may also be outfitted upon behind-and-over-the-ear type structure 49, as an example and as shown in FIG. 62. FIG. 63 is a depiction of an alternative around-the-neck type support structure having U-shaped structure 55 with a female port; and FIG. 64 is a depiction of another alternative around-the-neck type support structure showing abbreviated sleeves 25 for retaining signal-conducting wire(s) 14 outfitted with male connecters 97 as positioned adjacent an audio signal player 107.

showing abbreviated sleeves 25 for retaining signal-conducting wire(s) 14 outfitted with male connecters 97 as positioned adjacent an audio signal player 107.

Further, it is contemplated that the post 42 (or similar structure) of an earbud device (at exemplified by 43) could be inserted through an earlobe or a user's ear 12 (not specifically illustrated) so as to position the earbud device adjacent the user's ear according to the principles set forth hereinabove. These types of structural considerations are believed supported by the foregoing descriptions, and thus within the spirit of the present invention.

In addition to the foregoing structural considerations, it is further contemplated that the same support certain new and useful methods for directing earphone-based auditory stimuli toward a user's ear, which method essentially functions to further enhance the user's personal safety while receiving earphone-based auditory stimuli. In this regard, it is contemplated that the method may be said to comprise the steps of outfitting at least one earphone device with certain earphone positioning means (as heretofore exemplified) whereafter the primary earphone device may be positioned adjacent the user's ear via said earphone positioning means. Once positioned, auditory stimuli may be simultaneously directed toward the user's ear from both the primary earphone device and at least one secondary auditory source. Auditory stimuli may thus be simultaneously and unobstructedly received from the primary earphone device and at least one secondary auditory source by the user's ear for enhancing the user's personal safety while receiving earphone-based auditory stimuli.

The method may further comprise the steps of removably fastening the primary earphone device to an article of clothing worn by the user or similar other earphone support structure whereafter the primary earphone device may be adjusted for enhancing directed delivery of the earphone-based auditory stimuli toward the user's ear. The adjustment step may be further defined by certain means for triaxially adjusting portions of the primary earphone device by displacing first and second earphone arm portions away from one another thereby exposing certain means for effecting triaxial adjustment.

Accordingly, although the invention has been described by reference to certain preferred embodiment(s) and certain methodology, it is not intended that the novel arrangement and methods be limited thereby, but that modifications thereof are intended to be included as falling within the broad scope and spirit of the foregoing disclosures and the appended drawings.

I claim:

1. A system for enabling a user to simultaneously receive auditory stimuli from an earphone-based source and at least one secondary source, said system for enhancing a user's personal safety while listening to earphone-based auditory stimuli, said system comprising, in combination:
at least one primary earphone device, each primary earphone device comprising a loudspeaker for converting electrical signals into earphone-based auditory stimuli, the earphone-based auditory stimuli being receivable via a user's ear; and
earphone positioning means for enabling the user to position each primary earphone device adjacent a respective user's ear, said means thus enabling auditory stimuli from at least one secondary source to be simultaneously and unobstructedly received by the respective user's ear for enhancing the user's personal safety while receiving earphone-based auditory stimuli.

2. The system of claim 1 wherein said earphone positioning means comprise fastening means for enabling the user to removably fasten each primary earphone device earphone to support structure.

3. The system of claim 2 comprising adjustment means for enabling the user to adjust each primary earphone device for enhancing directed delivery of the earphone-based auditory stimuli toward the respective user's ear.

4. The system of claim 3 wherein said adjustment means comprise means for enabling triaxial adjustment of the primary earphone device.

5. The system of claim 4 wherein said adjustment means are enabled by axially displacing a first earphone arm portion away from a second earphone arm portion.

6. The system of claim 1 comprising at least one secondary earphone device, said earphone positioning means for enabling the user to position the secondary earphone device adjacent the respective user's ear.

7. The system of claim 1 wherein each primary earphone device comprises an earphone arm and wire positioning means for enabling the user to orient a signal delivery wire in parallel relation relative to the earphone arm.

8. An apparatus for enabling a user to simultaneously receive auditory stimuli from an earphone-based source and a secondary source, said apparatus for enhancing one's personal safety while listening to earphone-based auditory stimuli, said apparatus comprising:
a primary earphone device, the primary earphone device comprising a loudspeaker for creating earphone-based auditory stimuli, the earphone-based auditory stimuli being receivable via a user's ear; and
earphone positioning means for enabling the user to position the primary earphone device adjacent the user's ear, said means enabling auditory stimuli from at least one secondary source to be simultaneously and unobstructedly received by the user's ear for enhancing the user's personal safety while receiving the earphone-based auditory stimuli.

9. The apparatus of claim 8 wherein said earphone positioning means comprise fastening means for removably fastening the primary earphone device to support structure.

10. The apparatus of claim 8 comprising adjustment means for enabling primary earphone device adjustment for enhancing directed delivery of the earphone-based auditory stimuli.

11. The apparatus of claim 10 wherein said adjustment means comprise means for enabling triaxial primary earphone device adjustment.

12. The apparatus of claim 10 wherein said adjustment means are enabled by axially displacing a first earphone arm portion away from a second earphone arm portion.

13. The apparatus of claim 8 comprising wire positioning means and wherein the primary earphone device comprises an earphone arm, the wire positioning means for orienting an electrical signal delivery wire in parallel relation relative to the earphone arm.

14. The apparatus of claim 8 comprising a secondary earphone device, said earphone positioning means enabling the user to position the secondary earphone device adjacent the user's ear.

15. A method for enhancing personal safety while receiving earphone-based auditory stimuli, said method comprising the steps of:
outfitting a primary earphone device with earphone positioning means, said earphone positioning means for positioning the primary earphone device adjacent a user's ear;
positioning the primary earphone device adjacent the user's ear via said earphone positioning means;
simultaneously directing auditory stimuli toward the user's ear from both the primary earphone device and at least one secondary auditory source; and
simultaneously receiving unobstructed auditory stimuli from the primary earphone device and at least one secondary auditory source by the user's ear, the simultaneously received auditory stimuli for enhancing the user's personal safety while receiving earphone-based auditory stimuli.

16. The method of claim 15 wherein said earphone positioning means are removably fastened to support structure while positioning the primary earphone device adjacent the user's ear.

17. The method of claim 15 comprising the step of adjusting the primary earphone device for enhancing directed delivery of the earphone-based auditory stimuli toward the user's ear.

18. The method of claim 17 wherein the step of adjusting the primary earphone device is defined by triaxially adjusting a first portion of the primary earphone device relative to a second portion of the primary earphone device.

19. The method of claim 18 wherein the step of adjusting the primary earphone device is enabled by first displacing first and second earphone arm portions away from one another thereby exposing triaxial means for adjustment, the first earphone arm portion being triaxially adjustable relative to the second earphone arm portion.

20. The method of claim 15 wherein both the primary earphone device and a secondary earphone device are outfitted with said earphone positioning means, the method comprising the further steps of:
positioning the secondary earphone device adjacent the user's ear via said earphone positioning means;
simultaneously directing auditory stimuli toward the user's ear from both the primary and secondary earphone devices and at least one secondary auditory source; and
simultaneously receiving unobstructed auditory stimuli from the primary and secondary earphone devices and at least one secondary auditory source by the user's ear, the simultaneously received auditory stimuli for enhancing the user's personal safety while receiving earphone-based auditory stimuli.
